(19) United States
(12) Patent Application Publication
(10) Pub. No.: US 2026/0346686 A1
(43) Pub. Date: Nov. 5, 2026

(54) VISOR FOR A VEHICLE WITH AN ELECTROCHROMIC ELEMENT

(71) Applicant: Gentex Corporation, Zeeland, MI (US)

(72) Inventors: Peter Thomas Kantola, Ravenna, MI (US); Daniel T. Price, West Olive, MI (US); Joseph Clarke Redick, Middleville, MI (US); Eric P. Kern, Holland, MI (US); Eric S. Lundy, Holland, MI (US)

(73) Assignee: Gentex Corporation, Zeeland, MI (US)

(21) Appl. No.: 19/486,847

(22) PCT Filed: May 1, 2025
(86) PCT No.: PCT/IB2025/054589

§ 371 Date: Nov. 21, 2025

Related U.S. Application Data
(60) Provisional application No. 63/642,437, filed on May 3, 2024.

(51) Int. Cl. B60J 3/02; B32B 17/10; B60J 3/04

(52) U.S. Cl. CPC B60J 3/0278; B32B 17/10036; B32B 17/10513; B60J 3/04; B32B 2605/003

(57) ABSTRACT

A visor for a vehicle including (1) a body including (a) an electrochromic element configured to manipulate transmissivity of electromagnetic radiation of a predetermined wavelength or range of wavelengths therethrough; (b) a first position; and (c) a second position, the body manipulable to, from, and between the first position and the second position; (2) a position sensor configured to generate output indicative of (a) the body being in the first position and (b) manipulation of the body away from the first position; and (3) a controller in communication with the electrochromic element and the position sensor, the controller configured, as a function of the output that the position sensor generates indicative of the manipulation of the body away from the first position, to cause the electrochromic element to decrease the transmissivity of the electromagnetic radiation therethrough.

### CROSS-REFERENCE TO RELATED APPLICATION

This application claims priority to and the benefit under 35 U.S.C. § 119(e) of U.S. Provisional Patent Application No. 63/642,437, filed on May 3, 2024, entitled “VISOR FOR A VEHICLE WITH AN ELECTROCHROMIC ELEMENT,” by Peter Thomas Kantola et al., the entire disclosure of which is incorporated herein by reference.

### TECHNICAL FIELD

The present disclosure pertains to a visor for a vehicle and, more particularly, to such a visor with an electrochromic element.

### BACKGROUND

Despite advancements in autonomous vehicles, humans still operate a majority of the vehicles in service. In a typical setup, the passenger sits within an interior of the vehicle and looks forward through a windshield of the vehicle to an external environment. However, sometimes the Sun is disposed in a line of sight of the passenger, with the windshield separating the passenger from the Sun.

To address issues related to glare from the Sun, vehicles began to implement visors (sometimes called “Sun visors”) to help shade the eyes of the passenger from the Sun. Initially mounted to an exterior of the vehicle, sun visors were later adopted as an interior feature. Of those disposed in the interior, the visors were commonly attached to, or adjacent to, a ceiling of the interior and able to reposition between a stowed position relatively flush with the ceiling and a deployed position disposed between the eyes of the passenger and the Sun. The visors were formed of a non-transparent material such as fabric covered plastic.

However, there was a problem in that the visor, being non-transparent, left the passenger with a suboptimal view through the windshield and to the external environment.

### SUMMARY

The present disclosure addresses that problem with a visor that is visually transparent but includes an electrochromic element to alter the transmittance of electromagnetic radiation (e.g., visible light) from the external environment (e.g., from the Sun) that transmits through the electrochromic element and reaches the eyes of the passenger. The visor addresses the problem because the passenger can still see through the visor and then through the windshield to the external environment, unlike traditional opaque visors.

In addition, there is a problem that arises from the capability of the visor of the present disclosure to be moved between the stowed position and the deployed position. While in the stowed position, energy consumption concerns advise that the electrochromic element should be disabled—that is, draw little or no electrical power. With the electrochromic element disabled, the power consumption of the sun visor is lowered or minimized, and the visor provides its maximum degree of transmittance therethrough. In contrast, when the passenger manipulates the visor to the deployed position, it is reasonable to assume that the passenger desires at least some degree of electrochromic functionality to reduce the transmittance of the light from the external environment therethrough to reach the eyes of the passenger. However, with electrochromic mediums, there is some delay in transitioning to the level of reduction light intensity that the passenger desires. The passenger may find this delay suboptimal. In short, there is a conflict between maintaining little or no electrical energy draw while the visor is in the stowed position and providing the passenger with no noticeable delay in achieving the level of light intensity reduction desired while in the deployed position.

The present disclosure addresses this problem in several ways. First, in some embodiments, the visor includes a body with the electrochromic element, a position sensor, and a controller in communication with both the electrochromic element and the position sensor. As the controller understands from the position sensor that the body with electrochromic element has moved away from the stowed position towards the deployed position, the controller causes the electrochromic element to decrease transmittance therethrough. That approach permits the electrochromic element to draw little or no electrical power in the stowed position but reduces or eliminates lag time that the passenger perceives, because the transition to a lower transmittance occurs at least in part while the body is in transit to the deployed position.

Second, in some embodiments, the visor includes the position sensor, the controller, the electrochromic element, and a human-machine interface where the passenger can select the level of transmittance that the electrochromic element permits while the body is in the stowed position. That approach passes the balance judgment to the passenger. In other words, the passenger choses the level of transmittance while in the stowed position and thus the electrical power draw, and thus how much lag time if any that the passenger perceives after the body with the electrochromic element has moved to the deployed position.

Third, in some embodiments, the visor includes the body with the electrochromic element, the position sensor, the controller, and one or more data generators in communication with the controller. The one or more data generators generate output from which the controller can assume the Sun is within a line of sight of the passenger. With that assumption, the controller causes the electrochromic element to draw electrical power to decrease transmittance therethrough, anticipating that the passenger will soon manipulate the body to deployed position. The passenger thus perceives no lag time upon manipulating the body of the visor to the deployed position. If the one or more data generators generate output from which the controller can assume the Sun is not within a line of sight of the passenger, then the controller can cause the electrochromic element to draw little or no electrical power, because no reduction in transmittance is necessary.

According to one aspect of the present disclosure, a visor for a vehicle comprises: (1) a body comprising: (a) an electrochromic element configured to manipulate transmissivity of electromagnetic radiation of a predetermined wavelength or range of wavelengths therethrough; (b) a stowed position; and (c) a deployed position, the body manipulable to, from, and between the stowed position and the deployed position; (2) a position sensor configured to generate output indicative of (i) the body being in the stowed position and (ii) manipulation of the body away from the stowed position; (3) a human-machine interface in communication with the controller, the human-machine interface configured to generate output indicative of a selection of a passenger of the vehicle concerning a level of reduction in the transmittance of the electromagnetic radiation through the electrochromic element when the body is in the stowed position, the level of reduction being an intermediate level of transmittance reduction between a minimal transmittance reduction and a maximum transmittance reduction; and (4) a controller in communication with the electrochromic element and the position sensor, the controller configured, as a function of the output that the human-machine interface generates and as a function of the output that the sensor generates indicative of the body being in the stowed position, to cause the electrochromic element to achieve the level of reduction in the transmittance of the electromagnetic radiation therethrough according to the selection of the passenger until the position sensor generates output indicative of the manipulation of the body away from the stowed position.

According to another aspect of the present disclosure, a visor for a vehicle comprises: (1) a body comprising: (a) an electrochromic element configured to manipulate transmittance of electromagnetic radiation of a predetermined wavelength or range of wavelengths therethrough; (b) a stowed position; and (c) a deployed position, the body manipulable to, from, and between the stowed position and the deployed position; (2) a position sensor configured to generate output indicative of (i) the body being in the stowed position and (ii) manipulation of the body away from the stowed position; (3) one or more data generators configured to generate output indicative of a source of the electromagnetic radiation disposed within a line of sight of a passenger of the vehicle; and (4) a controller in communication with the electrochromic element and the one or more data generators, the controller configured, as a function of (i) the output that the sensor generates indicative of the body being in the stowed position and (ii) the output that the one or more data generators generate, to cause the electrochromic element to decrease the transmittance of the electromagnetic radiation therethrough while the body is in the stowed position.

These and other features, advantages, and objects of the present disclosure will be further understood and appreciated by those skilled in the art by reference to the following specification, claims, and appended drawings.

### BRIEF DESCRIPTION OF THE DRAWINGS

In the drawings:

FIG. 1 is a partial side elevational view into a vehicle including the visor of the present disclosure, illustrating the visor having a body in a first position (e.g., a stowed position) not within a line of sight of a passenger of the vehicle viewing through a windshield into an external environment;

FIG. 2 is a partial side elevational view into the vehicle, illustrating the body of the visor having been manipulated to a second position (e.g., a deployed position) within a line of sign of the passenger viewing through a windshield into the external environment and an electrochromic element of the body of the visor decreasing intensity of electromagnetic radiation emitted by the Sun before reaching an eye of the passenger;

FIG. 3 is a top perspective view of the visor with the body in the second position, illustrating the electrochromic element depending from at least a first frame member;

FIG. 4 is a partial side elevation view of a cross-section of the visor taken through line IV-IV of FIG. 3, illustrating the electrochromic element sandwiched between the first frame member and a second frame member, and the electrochromic element including an electrochromic medium;

FIG. 5 is a partial rear perspective view of the visor but without the first frame member, illustrating a printed circuit board with a controller and a position sensor thereupon and a human-machine interface connected to the printed circuit board;

FIG. 6 is a schematic diagram of the visor, or the vehicle generally, illustrating the controller controlling the electrochromic element, particular the transmittance therethrough, as a function of output received from one or more of the position sensor, the human-machine interface, and other data generators; and

FIG. 7 is a partial perspective view into an interior of the vehicle, illustrating the body of the visor in the first position (e.g., stowed position) against a ceiling of the vehicle but with the electrochromic element providing an intermediate transmittance reduction therethrough but still permitting sufficient transmittance through the body for the occupant to see a vehicle notification (e.g., an airbag warning label).

### DETAILED DESCRIPTION

The present illustrated embodiments reside primarily in combinations of method steps and apparatus components related to a visor for a vehicle with an electrochromic element. Accordingly, the apparatus components and method steps have been represented, where appropriate, by conventional symbols in the drawings, showing only those specific details that are pertinent to understanding the embodiments of the present disclosure so as not to obscure the disclosure with details that will be readily apparent to those of ordinary skill in the art having the benefit of the description herein. Further, like numerals in the description and drawings represent like elements.

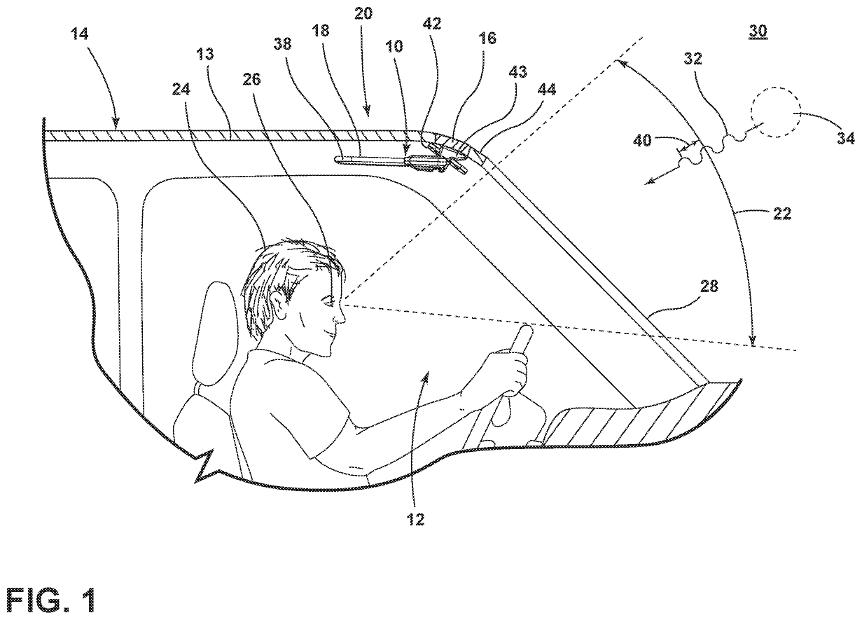

For purposes of description herein, the terms “upper,” “lower,” “right,” “left,” “rear,” “front,” “vertical,” “horizontal,” and derivatives thereof, shall relate to the disclosure as oriented in FIG. 1. Unless stated otherwise, the term “front” shall refer to a surface of the device closest to an intended viewer, and the term “rear” shall refer to a surface of the device furthest from the intended viewer. However, it is to be understood that the disclosure may assume various alternative orientations, except where expressly specified to the contrary. It is also to be understood that the specific devices and processes illustrated in the attached drawings, and described in the following specification are simply exemplary embodiments of the inventive concepts defined in the appended claims. Hence, specific dimensions and other physical characteristics relating to the embodiments disclosed herein are not to be considered as limiting, unless the claims expressly state otherwise.

The terms “including,” “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element preceded by “comprises a . . . ” does not, without more constraints, preclude the existence of additional identical elements in the process, method, article, or apparatus that comprises the element.

Referring first to FIG. 1, a visor 10 is herein described. The visor 10, in use, can be disposed at least in part within an interior 12 of a vehicle 14. For example, the vehicle 14 can include a structural support 16 that faces the interior 12 of the vehicle 14. The visor 10 can be coupled to the structural support 16. The visor 10 includes a body 18.

The body 18 of the visor 10 has a first position 20. In the first position 20, the body 18 is positioned to be excluded from a line of sight 22 of a passenger 24 of the vehicle 14. The line of sight 22 extends from an eye 26 of the passenger 24, through a windshield 28, and to an external environment 30. The first position 20 can be considered to be a “stowed” position. In the external environment 30 is electromagnetic radiation 32 that a source 34 has emitted. In the first position 20, the body 18 can be positioned approximately horizontally and adjacent a ceiling 13 of the vehicle 14.

The source 34 of the electromagnetic radiation 32 can be as a celestial object like the Sun. However, it should be understood that the visor 20 is also important and valuable in reducing glare/brightness when the Sun is not within the line of sight 22 of the passenger 24. There are well understood differences (or individuality) amongst human sensitivity to the amount of electromagnetic radiation 32 reaching the eye 26. There will be passenger 24 that will deploy the visor 10 and benefit from the dimming function as described herein reducing ambient light transmission to their eye 26 even when the Sun is not in view. For example, there could be reflections from the Sun on the road surface or an ocean or such things that are in addition to individual differences to brightness sensitivity. The source 34 then is considered broadly to include surfaces reflecting light, artificial light sources, the Sun, and so on. In short, the source 34 is not limited to the Sun being directly within the line of sight 22 of the passenger 34 but certainly encompasses such.

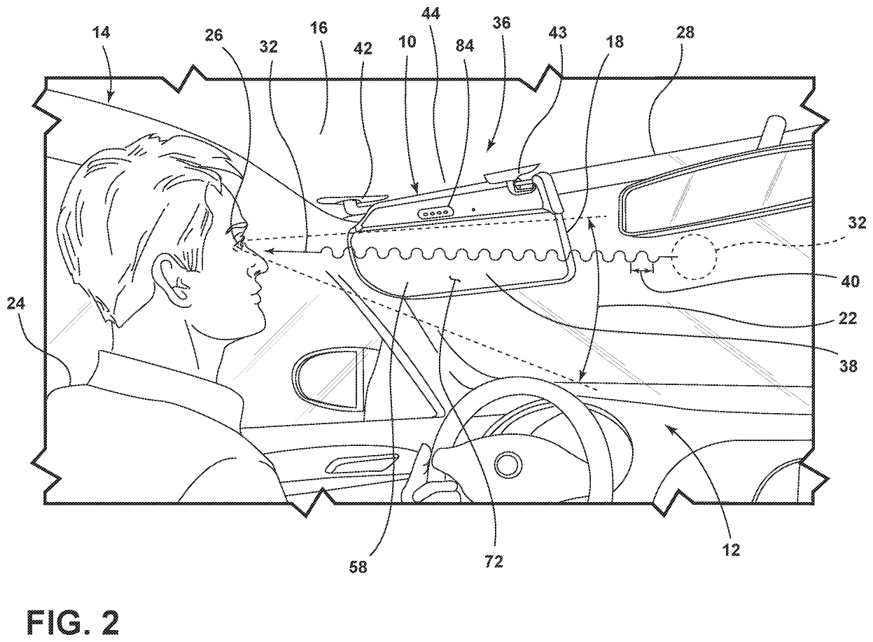

Referring additionally to FIG. 2, the body 18 further has a second position 36. In the second position 36, the body 18 is positioned to intersect, at least in part, with the line of sight 22 of the passenger 24. The second position 36 can be considered to be a “deployed” position. The visor 10 is manipulable to, from, and between the first position 20 (e.g. the stowed position) (FIG. 1) and the second position 36 (FIG. 2) (e.g., the deployed position).

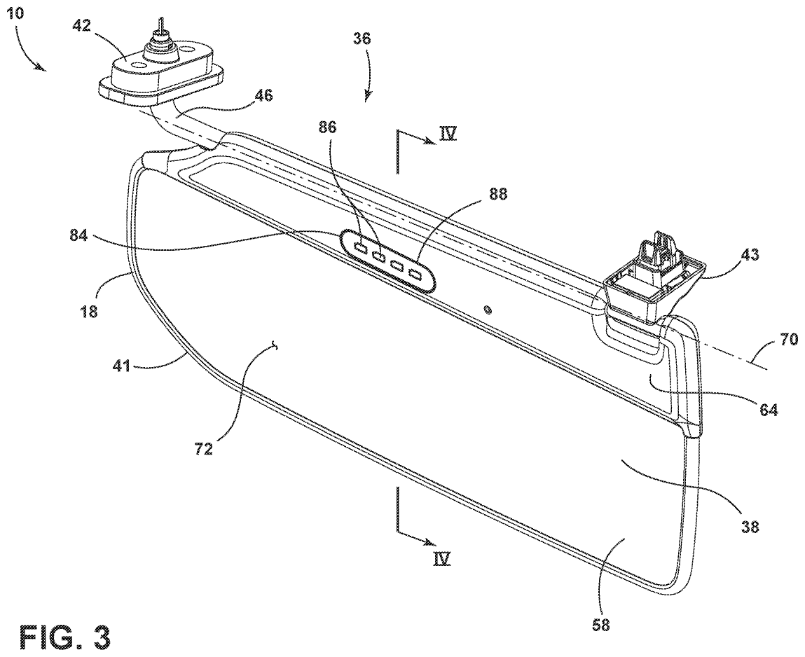

Referring additionally to FIG. 3, the body 18 includes an electrochromic element 38. The electrochromic element 38 is configured to manipulate the transmittance of a predetermined wavelength 40 (FIGS. 1 and 2) or range of wavelengths 40 of the electromagnetic radiation 32 therethrough. For example, the electrochromic element 38 can be configured to manipulate the transmittance of the visible spectrum of the electromagnetic radiation 32 therethrough. This aspect will be discussed further below. The body 18 can further include an edge covering 41 that at least partially surrounds a perimeter of the electrochromic element 38.

The visor 10 further includes a pivot mount 42 and a receptacle 43. The pivot mount 42 and the receptacle 43 are coupled to the structural support 16 of the vehicle 14, such as adjacent the windshield 28 at a headliner 44 (FIGS. 1 and 2). The pivot mount 42 and the receptacle 43 support and permit the manipulation of the body 18 to, from, and between the first position 20 and the second position 36. The visor 10 additionally includes a rod 46 rotatably coupled to at least the pivot mount 42.

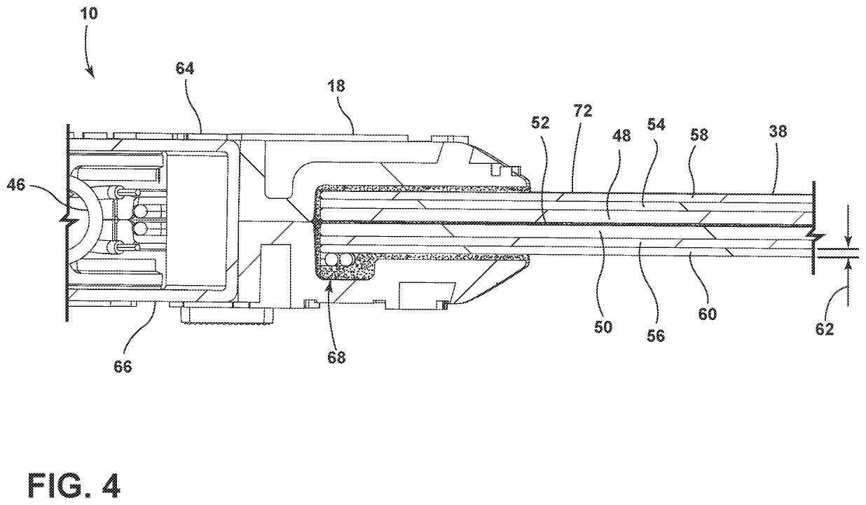

With reference now to FIG. 4, in embodiments, the electrochromic element 38 includes a first substrate 48, a second substrate 50, and an electrochromic medium 52 disposed between the first substrate 48 and the second substrate 50. In addition, the electrochromic element 38 includes a first polymer layer 54 disposed over the first substrate 48 and a second polymer layer 56 disposed over the second substrate 50. The first substrate 48, the second substrate 50, and the electrochromic medium 52 are disposed between the first polymer layer 54 and the second polymer layer 56. Further, the electrochromic element 38 includes a first glass layer 58 disposed over the first polymer layer 54 and a second glass layer 60 is disposed over the second polymer layer 56. The first polymer layer 54, the first substrate 48, the electrochromic medium 52, the second substrate 50, and the second polymer layer 56 are disposed between the first glass layer 58 and the second glass layer 60. The first glass layer 58 and the second glass layer 60 can be made of soda lime glass, among other options, such as a polymer (e.g., polycarbonate or coated polyethylene such as Spallshield®) and each has a thickness 62. In some instances, the thickness 62 may be greater than 0.1 mm. The first polymer layer 54 and the second polymer layer 56 can be formed of polyvinylpyrrolidone (PVP) or polyvinyl butyral (PVB), among other options. The edge covering 41 covers the perimeter edges of the first substrate 48, the second substrate 50, the first polymer layer 54, the second polymer layer 56, the first glass layer 58, and the second glass layer 60. Other embodiments of the electrochromic element 38 can include different components.

One or both of the first substrate 48 and the second substrate 50 can include respective conductive material coatings on the opposing surfaces thereof that are facing the electrochromic medium 52 to facilitate application of the electric potential to the electrochromic medium 52. The change in electric potential changes the transmittance through the electrochromic element 38. The conductive coatings can include transparent conductive oxide (TCO) coatings. For example, the conductive material may be a TCO such as indium tin oxide (ITO), indium zinc oxide (IZO), zinc oxide, and tin oxide, among other options.

As can be appreciated, the electrochromic medium 52 can take a number of different forms such as thermoplastic polymeric films, solution phase, or gelled phase. Illustrative electrochromic media are those as described in U.S. Pat. No. 4,902,108 (solution phase); U.S. Pat. No. 5,888,431 (gelled phase); U.S. Pat. No. 5,940,201 (gelled phase); U.S. Pat. No. 6,057,956 (gelled phase); U.S. Pat. No. 6,268,950 (gelled phase); U.S. Pat. No. 6,635,194 (gelled phase); U.S. Pat. No. 8,928,966 (gelled phase); U.S. Pat. No. 10,539,853 (thermoplastic polymeric films); and U.S. Patent Application Publication No. 2002/0015214 (solution phase), the entire contents of which are hereby incorporated by reference herein. The anodic and cathodic electrochromic materials within the electrochromic medium 52 can also include coupled materials as described in U.S. Pat. No. 6,249,369, which is incorporated herein by reference. The concentration of the electrochromic materials can be selected as taught in U.S. Pat. No. 6,137,620, which is incorporated herein by reference. Additionally, a single-layer, single-phase medium may include a medium where the anodic and cathodic materials are incorporated into a polymer matrix as is described in International Patent Applications Serial Nos. PCT/EP98/03862 and PCT/US98/05570, which are incorporated herein by reference.

The electrochromic medium 52 may be multilayer or multiphase. In multilayered, the medium may be made up in layers and includes an electroactive material attached directly to an electrically conducting electrode or confined in close proximity thereto which remains attached or confined when electrochemically oxidized or reduced. In multiphase, one or more materials in the medium undergo a change in phase during the operation of the device, for example a material contained in solution in the ionically conducting electrolyte forms a separate layer on the electrically conducting electrode when electrochemically oxidized or reduced.

The electrochromic medium 52 may include materials such as, but not limited to, anodics, cathodics, light absorbers, light stabilizers, thermal stabilizers, antioxidants, thickeners, viscosity modifiers, tint providing agents, redox buffers, and mixtures thereof. According to some embodiments, the anodic materials may include, but are not limited to, ferrocenes, ferrocenyl salts, phenazines, phenothiazines, and thianthrenes. The anodic materials may also include those incorporated into a polymer film such as polyaniline, polythiophenes, polymeric metallocenes, or a solid transition metal oxide, including, but not limited to, oxides of vanadium, nickel, iridium, as well as numerous heterocyclic compounds. Other anodic materials may include those as described in U.S. Pat. Nos. 4,902,108; 6,188,505; and 6,710,906, which are incorporated herein by reference. In any of the above aspects, the anodic material may be a phenazine, a phenothiazine, a triphenodithiazine, a carbazole, an indolocarbazole, a biscarbazole, or a ferrocene confined within the second polymer matrix, the second polymer matrix configured to prevent or minimize substantial diffusion of the anodic material in the activated state.

Cathodic materials may include, for example, viologens, such as methyl viologen, octyl viologen, or benzyl viologen; and ferrocinium salts, such as (6-(tri-tert butylferrocenium)hexyl) triethylammonium. While specific cathodic materials have been provided for illustrative purposes only, numerous other conventional cathodic materials are likewise contemplated for use including, but by no means limited to, those disclosed in previously referenced and incorporated U.S. Pat. Nos. 4,902,108; 6,188,505; and 6,710,906, which are incorporated herein by reference. Moreover, it is contemplated that the cathodic material may include a polymer film, such as various polythiophenes, polymeric viologens, an inorganic film, or a solid transition metal oxide, including, but not limited to, tungsten oxide. The cathodic material may be a protic soluble electrochromic material (e.g., soluble in a protic solvent such as an alcohol and/or water), or a single component electrochromic material (e.g., the electrochromic material includes a compound that includes both cathodic and anodic moieties in the same molecule or cation/anion combination), such as described in U.S. Provisional Appl. Nos. 62/257,950, filed on Nov. 20, 2015, and 62/258,051, filed on Nov. 20, 2015, which are incorporated herein by reference. Further examples of anodic and cathodic materials may be found in U.S. Pat. Nos. 4,902,108; 5,294,376; 5,998,617; 6,193,912; and 8,228,590, which are incorporated herein by reference.

For illustrative purposes only, the concentration of the anodic and/or cathodic materials in the electrochromic medium 52 can range from approximately 1 millimolar (mM) to approximately 500 mM and more preferably from approximately 2 mM to approximately 100 mM. While particular concentrations of the anodic as well as cathodic materials have been provided, it will be understood that the desired concentration may vary greatly depending upon the geometric configuration of the chamber containing the electrochromic medium 52.

For purposes of the present disclosure, a solvent of the electrochromic medium 52 may comprise any of a number of common, commercially available solvents including 3-methylsulfolane, dimethyl sulfoxide, dimethyl formamide, tetraglyme and other polyethers; alcohols such as ethoxyethanol; nitriles, such as acetonitrile, glutaronitrile, 3-hydroxypropionitrile, and 2-methylglutaronitrile; ketones including 2-acetylbutyrolactone, and cyclopentanone; cyclic esters including beta-propiolactone, gamma-butyrolactone, and gamma-valerolactone; organic carbonates including propylene carbonate (PC), ethylene carbonate and methyl ethyl carbonate; and mixtures of any two or more thereof.

The electrochromic medium 52 may include a thermoplastic polymer in which the electrochromic materials are confined (an “electrochromic thermoplastic”). Such media are described in U.S. Provisional Application No. 62/184,704, filed on May 25, 2015, which is incorporated herein by reference.

In some instances when the electrochromic medium 52 takes the form of a solution phase, the anodic material and the cathodic material are mixed together. The mixing together of the anodic material and the cathodic material allows the electrochromic medium 52 and the electrochromic element 38 to be self-erasing. As such, when no the electrochromic element 38 draws no current the electrochromic element 38 is in its “clear” state with a maximum transmittance therethrough. When a current is drawn, the anodic material and the cathodic material are affected and the electrochromic element 38 takes a darkened state, with the transmittance therethrough reduced compared to the clear state. The level of transmittance change relative to the clear state is a function of the current drawn. The electrochromic element 38 must continue to draw electrical current to prevent the electrochromic element 38 from self-erasing and thereby to continue to be in a darkened state.

In other instances, the electrochromic medium 52 has “memory” in that the electrochromic element 38 does not need to draw a current in order to maintain the clear state or the darkened state, whichever one is already present. An example is where the anodic material and the cathodic material are separated from each other, such as by an electrolyte layer. The anodic material remains associated with just the anodic conductive coating, while the cathodic material remains associated with just the cathodic conductive coating. While the electrochromic element 38 has to draw an electrical current to manipulate the electrochromic medium 52 to alter transmittance therethrough to the desired transmittance, the electrochromic medium 52 stays at that state without need to draw further electrical current.

The body 18 can further include a first frame member 64 and a second frame member 66 opposing the first frame member 64. The first frame member 64 and the second frame member 66 define a channel 68 therebetween. A portion of the electrochromic element 38 is disposed within the channel 68. The first frame member 64 and the second frame member 66 can thus support the electrochromic element 38.

In addition, the first frame member 64 and the second frame member 66 encircle a circumference of the rod 46. The body 18 is thus rotatable about an axis of rotation 70 (FIG. 3) while the body 18 is manipulated to, from, and between the first position 20 and the second position 36. The axis of rotation 70 extends through the rod 46.

The first glass layer 58 presents a first primary surface 72 that is positioned to face the eye 26 of the passenger 24 while the body 18 is in the second position 36 (e.g., the deployed position, FIG. 2). The line of sight 22 of the passenger 24 extends from the eye 26 of the passenger 24, through the first glass layer 58, the first polymer layer 54, the first substrate 48, the electrochromic medium 52, the second substrate 50, the second polymer layer 56, the second glass layer 60, through the windshield 28, and into the external environment 30. A perimeter seal can enclose the electrochromic medium 52 between the first substrate 48 and the second substrate 50.

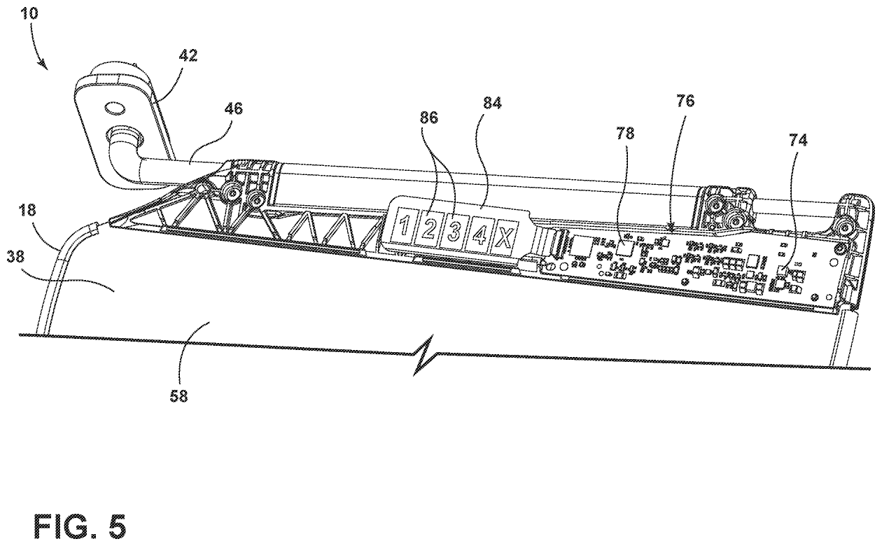

Referring now to FIG. 5, the visor 10 includes a position sensor 74. The position sensor 74 can be a component of a printed circuit board 76, as illustrated. The position sensor 74 is configured to generate output indicative at least of (i) the body 18 being in the first position 20 (e.g., the stowed position) and (ii) manipulation of the body 18 away from the first position 20, such as to or toward the second position 36. For example, the position sensor 74 can be an accelerometer, a hall-effect sensor, or other sensor type with position as feedback. The printed circuit board 76 can be housed between the first frame member 64 and the second frame member 66.

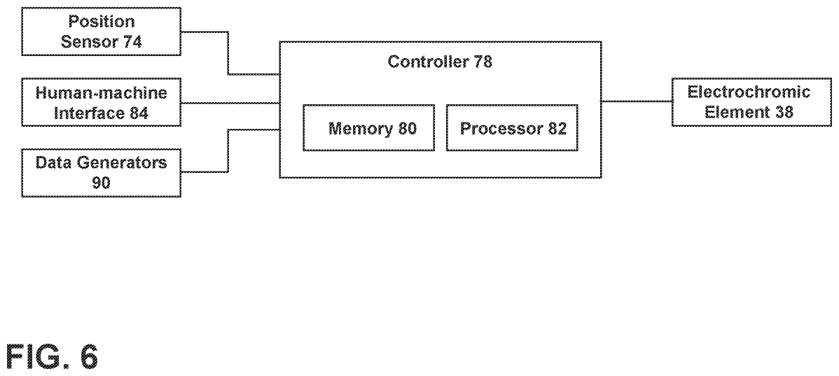

Referring additionally to FIG. 6, the visor 10, or the vehicle 14 generally, further includes a controller 78. The controller 78 can be another component of the printed circuit board 76. The controller 78 is in communication with both the electrochromic element 38 and the position sensor 74. In embodiments, the controller 78 is configured, as a function of the output that the position sensor 74 generates indicative of the manipulation of the body 18 away from the first position 20 (e.g., the stowed position), to cause the electrochromic element 38 to decrease the transmittance of the electromagnetic radiation 32 therethrough. In other words, as the controller 78 deciphers, based on the output of the position sensor 74, that the body 18 of the visor 10 has been manipulated away from the first position 20 (e.g., the stowed position) toward the second position 36 (e.g., the deployed position), the controller 78 can cause the electrochromic element 38 to become less transparent to visible light (e.g., decrease transmittance of visible light wavelengths). Thus, by the time that the body 18 is manipulated to the second position 36 (e.g., the deployed position) within the line of sight 22 of the passenger 24, or shortly thereafter, the body 18 of the visor 10 is shading the eye(s) 26 of the passenger 24. The controller 78 may include a memory 80 and a processor 82, the memory 80 contains instructions that, when executed by the processor 82, cause the processor 82 to control the functionality of the electrochromic element 38 as described herein.

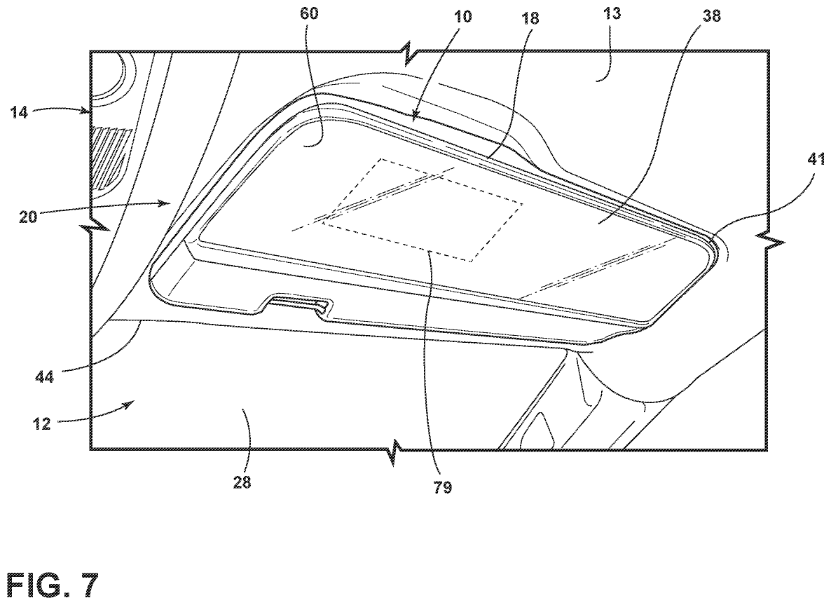

Because the controller 78 understands the position of the body 18 of the visor 10 due to the output of the position sensor 74, electrical power consumption of the electrochromic element 38 can be reduced while the body 18 is in the first position 20 (e.g., the stowed position) relative to when the body 18 is in the second position 36 (e.g., the deployed position). For example, while in the first position 20 (e.g., the stowed position), the controller 78 can cause the electrochromic element 38 to draw no electrical power. As a consequence of not drawing electrical power, the electrochromic element 38 imparts a minimized reduction on the transmittance of the electromagnetic radiation 32 therethrough. This minimal reduction may be quantified by the electrochromic element 38 transmitting greater than 70% of the electromagnetic radiation 32 (of the desired wavelength 40 or wavelength 40 range) incident upon the electrochromic element 38. In some instances, the minimal reduction may be quantified by a transmittance of 80% or more, or even 90% or more. In reference to FIG. 7, while the body 18 is in the first position 20 (e.g., the stowed position), and electrochromic element 38 imparts a minimized reduction on the transmittance of the electromagnetic radiation 32 therethrough, the occupant 24 is able to see a notification 79 (e.g., an airbag warning label) placed on the ceiling 13 or headliner 44 through the electrochromic element 38.

By way of comparison, when the controller 78 receives output from the position sensor 74 indicative of the base being manipulated away from the first position 20 (e.g., to or toward the second position 36), the controller 78 is configured to cause the electrochromic element 38 to transmit less than 50% of the electromagnetic radiation 32 incident upon the electrochromic element 38. In some instances, the reduction while shading can be quantified in transmittances through the electrochromic element 38 of less than 40%, less than 30%, less than 20%, less than 10%, or even less than 1%. Transmittance can be determined at an incident specular angle of 10°.

With reference again to FIG. 5, the visor 10, or the vehicle 14 generally, includes a human-machine interface 84. The human-machine interface 84 is in communication with the controller 78. At the human-machine interface 84, the passenger 24 of the vehicle 14 can select the transmittance of the electromagnetic radiation 32 through the electrochromic element 38 when the body 18 is in the first position 20 (e.g., the stowed position). The human-machine interface 84 then generates output to the controller 78 indicative of the selection. In such embodiments, the controller 78 is further configured, as a function of the output that the human-machine interface 84 generates and as a function of the output that the position sensor 74 generates indicative of the body 18 being in the first position 20 (e.g., the stowed position), to cause the electrochromic element 38 to achieve the transmittance of the electromagnetic radiation 32 therethrough according to the selection of the passenger 24 until the position sensor 74 generates output indicative of the manipulation of the body 18 away from the first position 20. Stated another way, the passenger 24 may not find the lag time of the electrochromic element 38 transitioning to a lower transmittance upon the body 18 being manipulated from the first position 20 (e.g., the stowed position) to the second position 36 (e.g., the deployed position) optimal, assuming that the electrochromic element 38 was in a state of zero or reduced electrical power draw while in the first position 20 (e.g., the stowed position). The human-machine interface 84 affords the passenger 24 with an opportunity to select a level of transmittance reduction (e.g., level of shading), and thus in some instance indirectly the level of electrical power draw (e.g., when the electrochromic medium 52 is a self-clearing solution phase), that the electrochromic element 38 provides while in the first position 20 (e.g., the stowed position). The human-machine interface 84 may provide several options via buttons 86 or the like, ranging from minimal transmittance reduction, a lower intermediate transmittance reduction, a higher intermediate transmittance reduction, and a maximum transmittance reduction. The minimal transmittance reduction would require the electrochromic element 38 to draw the minimum electrical power. The maximum transmittance reduction would require the electrochromic element 38 to draw the maximum electrical power. The lower intermediate transmittance reduction could be associated with the electrochromic element 38 drawing a lower indeterminate electrical power between the minimum electrical power and the maximum electrical power (e.g., when the electrochromic medium 52 is a self-clearing solution phase). The higher intermediate transmittance reduction could be associated with the electrochromic element 38 drawing a higher indeterminate electrical power between the lower intermediate electrical power and the maximum electrical power (e.g., when the electrochromic medium 52 is a self-clearing solution phase). The passenger 24 selecting the maximum transmittance reduction could cause the electrochromic element 38 to draw the maximum electrical power while in both the first position 20 (e.g., the stowed position) and the second position 36 (e.g., the deployed position), thus decreasing energy efficiency, but removing the aforementioned lag time in change of transmissivity after the body 18 is manipulated from the first position 20 (e.g., the stowed position) to the second position 36 (e.g., the deployed position). The lower intermediate transmittance reduction and the higher intermediate transmittance reduction options provide different balances between electrical power draw and lag time. Note that when the electrochromic medium 52 is a “memory” device where anodic material and the cathodic materials are separated to prevent self-clearing, the draw of electrical power to provide intermediate transmittance reduction is less of an issue than in self-clearing devices. However, the lag time issue is still present and is addressed in the same manner.

In embodiments, the human-machine interface 84 is positioned on an exterior side 88 (FIG. 3) of the visor 10 facing the passenger 24 when the body 18 is in the second position 36 (e.g., the deployed position) (FIG. 2). In some instances, the controller 78 is configured so that electrochromic element 38 imparts a transmittance reduction in accordance with the passenger's 24 selection but not exceeding a transmittance reduction after which the notification 79 is no longer visible to the passenger 24. In other words, in those instances, the controller 78 maintains the visibility of the notification 79 to the passenger 24 through the electrochromic element 38 while the body 18 is in the first position 20 (e.g., the stowed position). The controller 78 imposes maximum reduction of transmittance through the electrochromic element 38 while in the first position 20 so that the notification 79 always remains visible. The lower intermediate transmittance reduction and the higher intermediate transmittance reduction are still selectable options—the notification 79 remains visible in either instance however.

In embodiments with the human-machine interface 84, the controller 78 is configured to control the electrochromic element 38 both as a function of output from the position sensor 74 and as a function of output from the human-machine interface 84. Depending on the selection of the passenger 24, the controller 78 can still cause the electrochromic element 38 to further decrease the transmittance of the electromagnetic radiation 32 therethrough, upon receiving output from the position sensor 74 indicative of manipulation of the body 18 away from the first position 20 (e.g., the stowed position). Again depending on the selection of the passenger 24 (e.g., full reduction in transmittance), the controller 78 can cause the electrochromic element 38 to not decrease the transmittance of the electromagnetic radiation 32 therethrough compared to when the base is in the second position 36 (e.g., the deployed position), upon receiving output from the position sensor 74 indicative of the base being in the first position 20 (e.g., the stowed position). In the latter instance, the controller 78 does not “clear” the electrochromic element 38 and, in some embodiments (e.g., self-clearing solution phase), maintains full electric power draw in order to maintain full transmittance reduction. In some instances, after the passenger 24 selects an intermediate transmittance reduction option, the controller 78 causes the electrochromic element 38 to impart an intermediate reduction on the transmittance of the electromagnetic radiation 32 therethrough, while in the first position 20 (e.g., the stowed position). If the device is self-clearing, then the the controller 78 causes the electrochromic element 38 to draw an intermediate amount of electrical power in order to impart the intermediate reduction of the transmittance therethrough while in the first position 20. After the body 18 is manipulated away from the first position 20 (e.g., the stowed position) to or towards the second position 36 (e.g., the deployed position), the controller 78 is further configured to cause the electrochromic element 38 to impart a reduction on the transmittance of the electromagnetic radiation 32 therethrough that is greater than the intermediate reduction of the transmittance while it was in the first position 20 (e.g., the stowed position). That may require the controlled 78 causing the electrochromic element 38 to draw an amount of electrical power that is greater than the intermediate amount.

Referring back to FIGS. 1 and 2 and also to FIG. 6, in several embodiments, the visor 10, or the vehicle 14 generally, further includes one or more data generators 90. The one or more data generators 90 is in communication with the controller 78. The one or more data generators 90 is configured to generate output indicative of the source 34 of the electromagnetic radiation 32 disposed within the line of sight 22 of the passenger 24 of the vehicle 14. For example, the one or more data generators 90 can include a light sensor, a global positioning service device, a compass, a clock, and a weather sensor. In such embodiments, the controller 78 is configured to, as a function of (i) the output that the position sensor 74 generates indicative of the body 18 being in the first position 20 (e.g., the stowed position) and (ii) the output that the one or more data generators 90 generate, to cause the electrochromic element 38 to decrease the transmittance of the electromagnetic radiation 32 therethrough. In short, the controller 78 is configured to cause the electrochromic element 38 to pre-darken while in the first position 20 (e.g., the stowed position), anticipating the passenger 24 manipulation of the body 18 of the visor 10 from the first position 20 (e.g., the stowed position) to the second position 36 (e.g., the deployed position). Then, when the passenger 24 manipulates the body 18 of the visor 10 away from the first position 20 (e.g., the stowed position), the controller causes the electrochromic element 38 to impart a reduction of transmittance that is greater than or equal to the reduction in transmittance while in the first position 20 (e.g., the stowed position). In embodiments, the controller 78 is configured so that the notification 79 remains visible through the electrochromic element 38 even while pre-darkened in the first position 20 there is still a reduction in transmittance through the electrochromic element 38, just not so much that the notification 79 becomes not visible to the passenger 24.

Taking the example of the light sensor, the controller 78 can deduce from output that the light sensor generates that the Sun is within the line of sight 22 of the passenger 24. If the controller 78 deduces that the Sun is within the line of sight 22 of the passenger 24, then it is reasonable to assume that the passenger 24 might manipulate the body 18 of the visor 10 from the first position 20 (e.g., the stowed position) to the second position 36 (e.g., the deployed position), in order to reduce glare and the intensity of the electromagnetic radiation 32 reaching the eye(s) 26 of the passenger 24. The controller 78 can then cause the electrochromic element 38 to decrease transmittance therethrough, while the body 18 is still in the first position 20 (e.g., the stowed position), and before the body 18 is manipulated to the second position 36 (e.g., the deployed position). When the body 18 is moved to the second position 36 (e.g., the deployed position), the controller 78 causes the electrochromic element 38 to maintain (or further decrease) the transmittance therethrough. The potential issue with lag time is avoided or reduced. In the event that the light sensor generates output from which the controller 78 deduces the Sun is no longer within the line of sight 22 of the passenger 24, while the body 18 is in the first position 20 (e.g., the stowed position), then the controller 78 can cause or allow the electrochromic element 38 to “clear” and not thereafter draw electrical power (or a minimum electrical power) to decrease transmittance therethrough. The manipulation of the body 18 to the second position 36 (e.g., the deployed position) is no longer anticipated, lag time is not foreseen as an issue, and minimizing electrical power draw is instead addressed.

The controller 78 can be configured to make similar conclusions as to the positioning of the Sun based on the other of the one or more data generators 90. The controller 78 can deduce from the clock the time of the day and, therefrom, whether the Sun has risen or has set. If the Sun has set, then the controller 78 can cause the electrochromic element 38 to clear and not draw electrical power. If the Sun has risen, then the controller 78 can cause the electrochromic element 38 to decrease transmittance therethrough, anticipating a reasonable chance of manipulation of the body 18 to the second position 36 (e.g., the deployed position). The controller 78 can deduce from the compass, and the clock, that the vehicle 14 is bearing in a direction toward the Sun, and control the electrochromic element 38 accordingly. The same can be said for the global positioning service. From the weather sensor, the controller 78 can deduce that there is precipitation in the external environment 30 and conclude that the Sun is not highly visible and control the electrochromic element 38 accordingly.

The one or more data generators 90 and the human-machine interface 84 are not mutually exclusive—the visor 10 or the vehicle 14 generally can include both. For example, assuming that the passenger 24 selects via the human-machine interface 84 that the controller 78 is to cause the electrochromic element 38 to achieve the low intermediate level of reduction in the transmittance while in the first position 20 (e.g., the stowed position), the controller 78 can be configured to rely on the output that the one or more data generators 90 generate indicative of the source 34 (e.g., the Sun) being in the line of sight 22 to cause the electrochromic element 38 to achieve a further decrease in the transmittance (e.g., the high intermediate level of reduction) while in the first position (e.g., the stowed position). As the controller 78 receives output from the position sensor 74 indicative of the of the body 18 having been manipulated away from the first position 20 (e.g., the stowed position) toward or to the second position 36 (e.g., the deployed position), the controller 78 can maintain the decrease in transmittance implemented as a result of the output of the one or more data generators 90. The passenger 24 then perceives no lag in the electrochromic element 38. Alternatively, as the controller 78 receives output from the position sensor 74 indicative of the of the body 18 having been manipulated away from the first position 20 (e.g., the stowed position) toward or to the second position 36 (e.g., the deployed position), the controller 78 can further decrease transmittance through the electrochromic element 38 (e.g., change from the high intermediate decrease in transmittance to the maximum decrease in transmittance). The passenger 24 perceives little or no lag as a result of the transition yet the electrochromic element 38 utilizes reduced electricity while in the first position 20 (e.g., the stowed position) compared to while in the second position 36 (e.g., the deployed position).

It will be understood by one having ordinary skill in the art that construction of the described disclosure and other components is not limited to any specific material. Other exemplary embodiments of the disclosure disclosed herein may be formed from a wide variety of materials, unless described otherwise herein.

For purposes of this disclosure, the term “coupled” (in all of its forms, couple, coupling, coupled, etc.) generally means the joining of two components (electrical or mechanical) directly or indirectly to one another. Such joining may be stationary in nature or movable in nature. Such joining may be achieved with the two components (electrical or mechanical) and any additional intermediate members being integrally formed as a single unitary body with one another or with the two components. Such joining may be permanent in nature or may be removable or releasable in nature unless otherwise stated.

It is also important to note that the construction and arrangement of the elements of the disclosure, as shown in the exemplary embodiments, is illustrative only. Although only a few embodiments of the present innovations have been described in detail in this disclosure, those skilled in the art who review this disclosure will readily appreciate that many modifications are possible (e.g., variations in sizes, dimensions, structures, shapes and proportions of the various elements, values of parameters, mounting arrangements, use of materials, colors, orientations, etc.) without materially departing from the novel teachings and advantages of the subject matter recited. For example, elements shown as integrally formed may be constructed of multiple parts, or elements shown as multiple parts may be integrally formed, the operation of the interfaces may be reversed or otherwise varied, the length or width of the structures and/or members or connector or other elements of the system may be varied, the nature or number of adjustment positions provided between the elements may be varied. It should be noted that the elements and/or assemblies of the system may be constructed from any of a wide variety of materials that provide sufficient strength or durability, in any of a wide variety of colors, textures, and combinations. Accordingly, all such modifications are intended to be included within the scope of the present innovations. Other substitutions, modifications, changes, and omissions may be made in the design, operating conditions, and arrangement of the desired and other exemplary embodiments without departing from the spirit of the present innovations.

According to a first aspect of the present disclosure, a visor for a vehicle comprises: (1) a body comprising: (a) an electrochromic element configured to manipulate transmissivity of electromagnetic radiation of a predetermined wavelength or range of wavelengths therethrough; (b) a stowed position; and (c) a deployed position, the body manipulable to, from, and between the stowed position and the deployed position; (2) a position sensor configured to generate output indicative of (i) the body being in the stowed position and (ii) manipulation of the body away from the stowed position; (3) a human-machine interface in communication with the controller, the human-machine interface configured to generate output indicative of a selection of a passenger of the vehicle concerning a level of reduction in the transmittance of the electromagnetic radiation through the electrochromic element when the body is in the stowed position, the level of reduction being an intermediate level of transmittance reduction between a minimal transmittance reduction and a maximum transmittance reduction; and (4) a controller in communication with the electrochromic element and the position sensor, the controller configured, as a function of the output that the human-machine interface generates and as a function of the output that the sensor generates indicative of the body being in the stowed position, to cause the electrochromic element to achieve the level of reduction in the transmittance of the electromagnetic radiation therethrough according to the selection of the passenger until the position sensor generates output indicative of the manipulation of the body away from the stowed position.

According to a second aspect of the present disclosure, the visor of the first aspect is presented, wherein in the stowed position, the body of the visor is positioned to be excluded from a line of sight of the passenger of the vehicle through a windshield of the vehicle into an external environment.

According to a third aspect of the present disclosure, the visor of any one of the first through second aspects is presented, wherein in the deployed position, the body of the visor is positioned to intersect with a line of sight of the passenger of the vehicle through a windshield of the vehicle into an external environment.

According to a fourth aspect of the present disclosure, the visor of any one of the first through third aspects is presented, wherein the electrochromic element comprises a first substrate, a second substrate, and an electrochromic medium disposed between the first substrate and the second substrate.

According to a fifth aspect of the present disclosure, the visor of the fourth aspect is presented, wherein the electrochromic element further comprises (i) a first polymer layer disposed over the first substrate and (ii) a second polymer layer disposed over the second substrate, with the first substrate, the second substrate, and the electrochromic element disposed between the first polymer layer and the second polymer layer.

According to a sixth aspect of the present disclosure, the visor of the fifth aspect is presented, wherein the electrochromic element further comprises (i) a first glass layer disposed over the first polymer layer and (ii) a second glass layer disposed over the second polymer layer, with the first polymer layer, the first substrate, the electrochromic medium, the second substrate, and the second polymer layer disposed between the first glass layer and the second glass layer.

According to a seventh aspect of the present disclosure, the visor of the sixth aspect is presented, wherein while the body of the visor is in the deployed position, the electrochromic device is positioned so that a line of sight of the passenger of the vehicle extends through the first glass layer, the first polymer layer, the first substrate, the electrochromic medium, the second substrate, the second polymer layer, and the second glass layer.

According to an eighth aspect of the present disclosure, the visor of any one of the first through seventh aspects is presented, wherein the body further comprises a first frame member and a second frame member opposing the first frame member, the first frame member and the second frame member defining a channel therebetween within which a portion of the electrochromic element is disposed.

According to a ninth aspect of the present disclosure, the visor of any one of the first through eighth aspects is presented, wherein the body further comprises a pivot mount configured to attach to a structural support of a vehicle and configured to permit manipulation of the body of the visor to, from, and between the stowed position and the deployed position about an axis of rotation.

According to a tenth aspect of the present disclosure, the visor of any one of the first through ninth aspects is presented, wherein the controller is further configured, as a function of the output that the position sensor generates indicative of the manipulation of the body away from the stowed position, to cause the electrochromic element to further decrease the transmittance of the electromagnetic radiation therethrough beyond the intermediate level of reduction of the transmittance while in the stowed position.

According to an eleventh aspect of the present disclosure, the visor of any one of the first through tenth aspects is presented, wherein (i) the controller is configured, as a function of the output that the position sensor generates indicative of the base being in the stowed position, to cause the electrochromic element to draw an intermediate amount of electrical power between a minimal amount of electrical power and a maximum amount of electrical power, the intermediate amount of electrical power used to impart an intermediate reduction of the transmittance of the electromagnetic radiation therethrough, and (ii) the controller is further configured, as a function of the output that the position sensor generates indicative of the base having been manipulated away from the stowed position, to cause the electrochromic element to draw an amount of electrical power that is greater than the intermediate amount and to impart a reduction on the transmittance of the electromagnetic radiation therethrough that is greater than the intermediate reduction.

According to a twelfth aspect of the present disclosure, the visor of any one of the first through eleventh aspects is presented, wherein the human-machine interface provides the passenger with selectable options comprising minimal transmittance reduction, a lower intermediate transmittance reduction, a higher intermediate transmittance reduction, and the maximum transmittance reduction.

According to a thirteenth aspect of the present disclosure, the visor of any one of the first through twelfth aspects further comprises one or more data generators configured to generate output indicative of a source of the electromagnetic radiation disposed within a line of sight of a passenger of the vehicle, wherein, the controller is further configured, as a function of (i) the output that the sensor generates indicative of the body being in the stowed position and (ii) the output that the one or more data generators generate, to cause the electrochromic element to further decrease the transmittance of the electromagnetic radiation therethrough while the body is in the stowed position beyond the level of reduction that the passenger has selected.

According to a fourteenth aspect of the present disclosure, a visor for a vehicle comprises: (1) a body comprising: (a) an electrochromic element configured to manipulate transmissivity of electromagnetic radiation of a predetermined wavelength or range of wavelengths therethrough; (b) a stowed position; and (c) a deployed position, the body manipulable to, from, and between the stowed position and the deployed position; (2) a position sensor configured to generate output indicative of (i) the body being in the stowed position and (ii) manipulation of the body away from the stowed position; (3) one or more data generators configured to generate output indicative of a source of the electromagnetic radiation disposed within a line of sight of a passenger of the vehicle; and (4) a controller in communication with the electrochromic element and the one or more data generators, the controller configured, as a function of (i) the output that the sensor generates indicative of the body being in the stowed position and (ii) the output that the one or more data generators generate, to cause the electrochromic element to decrease the transmittance of the electromagnetic radiation therethrough while the body is in the stowed position.

According to a fifteenth aspect of the present disclosure, the visor of the fourteenth aspect is presented, wherein the one or more data generators comprise one or more of a light sensor, a global positioning service device, a compass, a clock, and a weather sensor.

According to a sixteenth aspect of the present disclosure, the visor of any one of the fourteenth through fifteenth aspects is presented, wherein the controller is further configured, as a function of the output that the position sensor generates indicative of the manipulation of the body of the visor away from the stowed position, to cause the electrochromic element to further decrease the transmittance of the electromagnetic radiation therethrough.

According to a seventeenth aspect of the present disclosure, the visor of any one of the fourteenth through sixteenth aspects is presented, wherein in the deployed position, the body of the visor is positioned to intersect with a line of sight of the passenger of the vehicle through a windshield of the vehicle into an external environment.

According to an eighteenth aspect of the present disclosure, the visor of any one of the fourteenth through seventeenth aspects is presented, wherein (i) the one or more data generators are further configured to generate output indicating of the source of the electromagnetic radiation not being disposed within a line of sight of the passenger, and (ii) the controller is further configured, as a function of the output that the one or more data generators generate, to cause the electrochromic element to minimally decrease the transmittance of the electromagnetic radiation therethrough while the body is in the stowed position.

According to a nineteenth aspect of the present disclosure, the visor of any one of the fourteenth through eighteenth aspects is presented, wherein (i) the controller if further configured, as a function of the output the one or more data generators generate indicative of the source of the electromagnetic radiation being disposed within the line of sight of the passenger, to cause the electrochromic element to impart an intermediate reduction of the transmittance of the electromagnetic radiation therethrough while the body is in the stowed position, and (ii) the controller is further configured, as a function of the output that the position sensor generates indicative of the body manipulated away from the stowed position, to cause the electrochromic element impart a reduction of transmittance of the electromagnetic radiation therethrough that is greater than or equal to the intermediate reduction while the body was in the stowed position.

According to a twentieth aspect of the present disclosure, the visor of any one of the fourteenth through nineteenth aspects further comprises a human-machine interface in communication with the controller, the human-machine interface configured to generate output indicative of a selection of a passenger of the vehicle concerning a level of reduction in the transmittance of the electromagnetic radiation through the electrochromic element when the body is in the stowed position, wherein, the controller is further configured, as a function of the output that the human-machine interface generates and as a function of the output that the sensor generates indicative of the body being in the stowed position, to cause the electrochromic element to achieve the level of reduction in the transmittance of the electromagnetic radiation therethrough according to the selection of the passenger until the controller causes, based on the output that the one or more data generators generate, the electrochromic element to further decrease the transmittance of the electromagnetic radiation therethrough while the body is in the stowed position.

According to a twenty-first aspect of the present disclosure, the visor of any one of the first through twentieth aspects is presented, wherein the controller is further configured to cause the electrochromic element to decrease the transmittance of the electromagnetic radiation therethrough while the body is in the stowed position only to a maximum decrease in transmittance at which a notification from the vehicle remains visible through the electrochromic element to the passenger.

According to a twenty-second aspect of the present disclosure, a vehicle comprising the visor of any one of the firs through twenty-first aspects, wherein the controller is associated with the vehicle or the visor, the human-machine interface is associated with the vehicle or the visor, and one or more of the sensors is associated with the vehicle or the visor.

It will be understood that any described processes or steps within described processes may be combined with other disclosed processes or steps to form structures within the scope of the present disclosure. The exemplary structures and processes disclosed herein are for illustrative purposes and are not to be construed as limiting.

1. A visor for a vehicle comprising:
a body comprising:
an electrochromic element configured to manipulate transmittance of electromagnetic radiation of a predetermined wavelength or range of wavelengths therethrough;
a stowed position; and
a deployed position, the body manipulable to, from, and between the stowed position and the deployed position;
a position sensor configured to generate output indicative of (i) the body being in the stowed position and (ii) manipulation of the body away from the stowed position;
a human-machine interface in communication with the controller, the human-machine interface configured to generate output indicative of a selection of a passenger of the vehicle concerning a level of reduction in the transmittance of the electromagnetic radiation through the electrochromic element when the body is in the stowed position, the level of reduction being an intermediate level of transmittance reduction between a minimal transmittance reduction and a maximum transmittance reduction; and
a controller in communication with the electrochromic element and the position sensor, the controller configured, as a function of the output that the human-machine interface generates and as a function of the output that the sensor generates indicative of the body being in the stowed position, to cause the electrochromic element to achieve the level of reduction in the transmittance of the electromagnetic radiation therethrough according to the selection of the passenger until the position sensor generates output indicative of the manipulation of the body away from the stowed position.

2. The visor of claim 1, wherein
in the stowed position, the body of the visor is positioned to be excluded from a line of sight of the passenger of the vehicle through a windshield of the vehicle into an external environment.

3. The visor of claim 1, wherein
in the deployed position, the body of the visor is positioned to intersect with a line of sight of the passenger of the vehicle through a windshield of the vehicle into an external environment.

4. The visor of claim 1, wherein
the electrochromic element comprises a first substrate, a second substrate, and an electrochromic medium disposed between the first substrate and the second substrate.

5. The visor of claim 4, wherein
the electrochromic element further comprises (i) a first polymer layer disposed over the first substrate and (ii) a second polymer layer disposed over the second substrate, with the first substrate, the second substrate, and the electrochromic element disposed between the first polymer layer and the second polymer layer.

6. The visor of claim 5, wherein
the electrochromic element further comprises (i) a first glass layer disposed over the first polymer layer and (ii) a second glass layer disposed over the second polymer layer, with the first polymer layer, the first substrate, the electrochromic medium, the second substrate, and the second polymer layer disposed between the first glass layer and the second glass layer.

7. The visor of claim 6, wherein
while the body of the visor is in the deployed position, the electrochromic device is positioned so that a line of sight of the passenger of the vehicle extends through the first glass layer, the first polymer layer, the first substrate, the electrochromic medium, the second substrate, the second polymer layer, and the second glass layer.

8. The visor of claim 1, wherein
the body further comprises a first frame member and a second frame member opposing the first frame member, the first frame member and the second frame member defining a channel therebetween within which a portion of the electrochromic element is disposed.

9. The visor of claim 1, wherein
the body further comprises a pivot mount configured to attach to a structural support of a vehicle and configured to permit manipulation of the body of the visor to, from, and between the stowed position and the deployed position about an axis of rotation.

10. The visor of claim 1, wherein
the controller is further configured, as a function of the output that the position sensor generates indicative of the manipulation of the body away from the stowed position, to cause the electrochromic element to further decrease the transmittance of the electromagnetic radiation therethrough beyond the intermediate level of reduction of the transmittance while in the stowed position.

11. The visor of claim 1, wherein
the controller is configured, as a function of the output that the position sensor generates indicative of the base being in the stowed position, to cause the electrochromic element to draw an intermediate amount of electrical power between a minimal amount of electrical power and a maximum amount of electrical power, the intermediate amount of electrical power used to impart an intermediate reduction of the transmittance of the electromagnetic radiation therethrough, and
the controller is further configured, as a function of the output that the position sensor generates indicative of the base having been manipulated away from the stowed position, to cause the electrochromic element to draw an amount of electrical power that is greater than the intermediate amount and to impart a reduction on the transmittance of the electromagnetic radiation therethrough that is greater than the intermediate reduction.

12. The visor of claim 1, wherein
the human-machine interface provides the passenger with selectable options comprising minimal transmittance reduction, a lower intermediate transmittance reduction, a higher intermediate transmittance reduction, and the maximum transmittance reduction.

13. The visor of claim 1 further comprising:
one or more data generators configured to generate output indicative of a source of the electromagnetic radiation disposed within a line of sight of a passenger of the vehicle,
wherein, the controller is further configured, as a function of (i) the output that the sensor generates indicative of the body being in the stowed position and (ii) the output that the one or more data generators generate, to cause the electrochromic element to further decrease the transmittance of the electromagnetic radiation therethrough while the body is in the stowed position beyond the level of reduction that the passenger has selected.

14. A visor for a vehicle comprising:
a body comprising:
an electrochromic element configured to manipulate transmittance of electromagnetic radiation of a predetermined wavelength or range of wavelengths therethrough;
a stowed position; and
a deployed position, the body manipulable to, from, and between the stowed position and the deployed position;
a position sensor configured to generate output indicative of (i) the body being in the stowed position and (ii) manipulation of the body away from the stowed position;
one or more data generators configured to generate output indicative of a source of the electromagnetic radiation disposed within a line of sight of a passenger of the vehicle; and
a controller in communication with the electrochromic element and the one or more data generators, the controller configured, as a function of (i) the output that the sensor generates indicative of the body being in the stowed position and (ii) the output that the one or more data generators generate, to cause the electrochromic element to decrease the transmittance of the electromagnetic radiation therethrough while the body is in the stowed position.

15. The visor of claim 14, wherein
the one or more data generators comprise one or more of a light sensor, a global positioning service device, a compass, a clock, and a weather sensor.

16. The visor of claim 14, wherein
the controller is further configured, as a function of the output that the position sensor generates indicative of the manipulation of the body of the visor away from the stowed position, to cause the electrochromic element to further decrease the transmittance of the electromagnetic radiation therethrough.

17. The visor of claim 14, wherein
in the deployed position, the body of the visor is positioned to intersect with a line of sight of the passenger of the vehicle through a windshield of the vehicle into an external environment.

18. The visor of claim 14, wherein
the one or more data generators are further configured to generate output indicating of the source of the electromagnetic radiation not being disposed within a line of sight of the passenger, and
the controller is further configured, as a function of the output that the one or more data generators generate, to cause the electrochromic element to minimally decrease the transmittance of the electromagnetic radiation therethrough while the body is in the stowed position.

19. The visor of claim 14, wherein
the controller is further configured, as a function of the output of the one or more data generators generate indicative of the source of the electromagnetic radiation being disposed within the line of sight of the passenger, to cause the electrochromic element to impart an intermediate reduction of the transmittance of the electromagnetic radiation therethrough while the body is in the stowed position, and
the controller is further configured, as a function of the output that the position sensor generates indicative of the body manipulated away from the stowed position, to cause the electrochromic element to impart a reduction of transmittance of the electromagnetic radiation therethrough that is greater than or equal to the intermediate reduction while the body was in the stowed position.

20. The visor of claim 14 further comprising:
a human-machine interface in communication with the controller, the human-machine interface configured to generate output indicative of a selection of a passenger of the vehicle concerning a level of reduction in the transmittance of the electromagnetic radiation through the electrochromic element when the body is in the stowed position,
wherein, the controller is further configured, as a function of the output that the human-machine interface generates and as a function of the output that the sensor generates indicative of the body being in the stowed position, to cause the electrochromic element to achieve the level of reduction in the transmittance of the electromagnetic radiation therethrough according to the selection of the passenger until the controller causes, based on the output that the one or more data generators generate, the electrochromic element to further decrease the transmittance of the electromagnetic radiation therethrough while the body is in the stowed position.

21. (canceled)
